(19) United States
(12) Patent Application Publication
(10) Pub. No.: US 2013/0068057 A1
(43) Pub. Date: Mar. 21, 2013

(54) IDLER GEAR ASSEMBLY FOR A GENERATOR

(71) Applicant: Andrew P. Grosskopf, Rockford, IL (US)

(72) Inventor: Andrew P. Grosskopf, Rockford, IL (US)

(73) Assignee: HAMILON SUNDSTRAND CORPORATION, Windsor Locks, CT (US)

(21) Appl. No.: 13/234,506

(22) Filed: Sep. 16, 2011

(51) Int. Cl. F16H 1/06; F16H 55/02

(52) U.S. Cl. 74/414; 74/640; 74/457; 74/462

(57) ABSTRACT

An idler gear assembly for a generator includes a first gear configured for coupling to a second gear. The first gear includes a first shaft aligned along a first shaft axis, the first shaft having a first shoulder with a first axial face and a second shoulder with a second axial face diametrically opposed from the first axial face, diametrically opposed first and second grooves about a circumference of the first shoulder and a first set of teeth circumferentially located about the first shaft axis, the first shaft includes a first axial distance from the first axial face to the second axial face. The second gear includes a second shaft aligned along a second shaft axis, the second shaft having a diametrically opposed first and second tangs, and a second set of teeth circumferentially located about the second shaft axis, the second shaft includes a second axial distance.

### FIELD OF INVENTION

This invention generally relates to an idler gear assembly for a generator and, more particularly, to a two-piece idler gear assembly for handling the expected stresses within the gear train of a generator oil supply pump.

### DESCRIPTION OF RELATED ART

Systems that include electrical generators can include a hydraulic pump for cooling the generator or other components of the system. The pump can be driven by the rotor of the generator though a gear train. Misalignment of the gears within the gear train relative to the shaft, bearings, or other components, may increase wear on the gears and contribute to a reduction in gear durability. For instance, axial misalignment of the gears may cause uneven wear of the gear teeth and eventually necessitate replacement. Pressure pulsations from the pump may also contribute to premature wear of the gears. Often, it is a combination of both axial misalignment and pressure pulsation conditions that contribute to premature wear of the gears.

### BRIEF SUMMARY

According to one aspect of the invention, an idler gear assembly for a generator includes a first gear and a second gear. The first gear includes a first shaft aligned along a first shaft axis from a first end to a diametrically opposed second end. The first shaft has a first shoulder with a first axial face and a second shoulder with a second axial face diametrically opposed from the first axial face, diametrically opposed first and second grooves about a circumference of the first shoulder and a first set of teeth circumferentially located about the first shaft axis. Also, the first shaft includes a first axial distance from the first axial face to the second axial face. The second gear includes a second shaft aligned along a second shaft axis, the second shaft having a diametrically opposed first and second tangs, and a second set of teeth circumferentially located about the second shaft axis. Also, the second shaft includes a second axial distance from a third end to a diametrically opposed fourth end. The first gear is configured for coupling to the second gear such that the first axial distance and the second axial distance cooperate to locate the first and second gears between diametrically opposed journal bearings, while each of the first shaft axis and the second shaft axis are configured for being aligned along the axis of rotation. Also, the first and second groves are configured for coupling to the first and second tangs.

According to another aspect of the invention, a shaft gear for a generator includes a shaft aligned along a shaft axis from a first end to a diametrically opposed second end, the shaft having a first shoulder with first axial face and a second shoulder with a second axial face diametrically opposed from the first axial face, diametrically opposed first and second grooves about a circumference of the first shoulder and a set of teeth circumferentially located about the shaft axis. The shaft includes an axial distance from the first axial face to the second axial face. The shaft has a first bearing surface defined by the first axial face and the first end of the shaft, with the shaft being configured for rotation about the shaft axis.

According to yet another aspect of the invention, a spur gear for a generator includes a shaft aligned along a shaft axis from a first end to a diametrically opposed second end, the shaft having diametrically opposed first and second tangs at the first end and an axial distance from the first end to the second end. The spur gear also includes a circular portion having opposed top and bottom surfaces, the circular portion being aligned along an axis that passes through a geometric center of the top and bottom surfaces, while the circular portion is coupled to the shaft at the geometric center. Also, the shaft is configured for rotation about the shaft axis, while the circular portion includes a set of teeth circumferentially located at a perimeter of the circular portion.

Other aspects, features, and techniques of the invention will become more apparent from the following description taken in conjunction with the drawings.

### BRIEF DESCRIPTION OF THE SEVERAL VIEWS OF THE DRAWINGS

Referring now to the drawings wherein like elements are numbered alike in the FIGURES:

FIG. 1 illustrates an example generator with an idler gear assembly in a gear train according to an embodiment of the invention;

FIG. 2A illustrates a perspective view of a first gear in the idler gear assembly of FIG. 1 according to an embodiment of the invention;

FIG. 2B illustrates a sectional view of the first gear shown in FIG. 2A taken along the line A-A according to an embodiment of the invention;

FIG. 3A illustrates a perspective view of a second gear in the idler gear assembly of FIG. 1 according to an embodiment of the invention;

FIG. 3B illustrates a sectional view of the second gear shown in FIG. 3A taken along the line B-B according to an embodiment of the invention; and

FIG. 4 illustrates a side view of gear teeth for the idler gear assembly of FIG. 1 according to an embodiment of the invention.

### DETAILED DESCRIPTION

Embodiments of an idler gear assembly include a first gear coupled to a second gear in a gear train of a generator. The first gear includes a first shaft that includes a first dimension for being received within a complementary bore of the second gear. The complementary bore has a second dimension for causing an interference lock between the first gear and the second gear. Additionally, drive tangs on a second shaft of the second gear are configured to be received within complementary apertures or grooves on a shoulder of the first shaft for reinforcing the connection between the first gear and the second gear and preventing the first gear from slipping out of frictional contact with the second gear and preventing rotation of the second gear relative to the first gear.

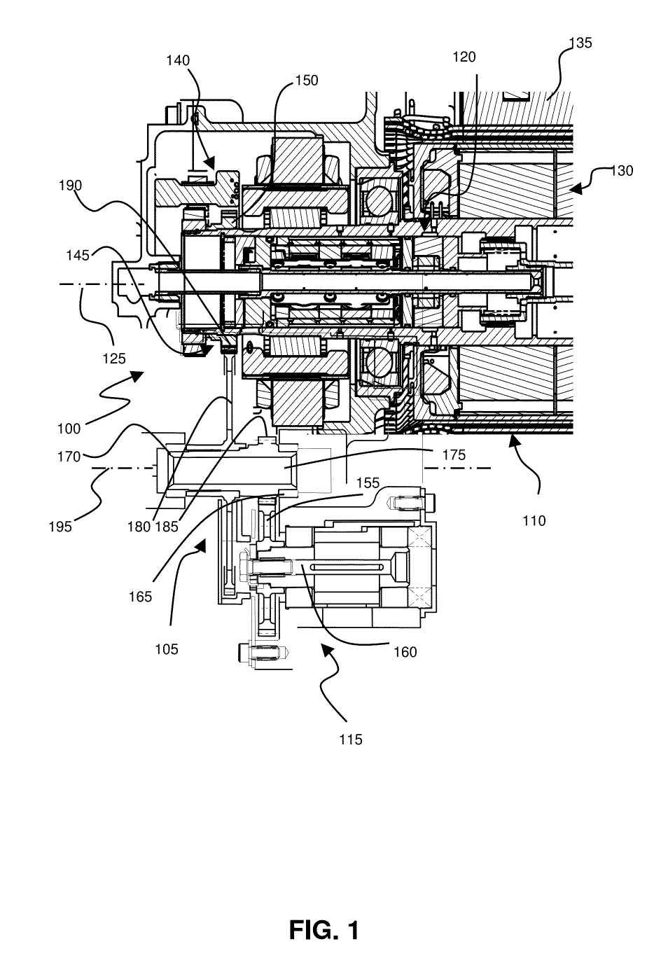

Referring to the drawings, FIG. 1 illustrates an example generator 100 including a two-piece idler gear assembly 105 according to an embodiment of the invention. Particularly, the generator 100 may be a high speed, variable frequency generator and includes the gear assembly 105 for driving a hydraulic pump. In the illustrated example, the generator 100 includes a dynamoelectric portion 110, a hydraulic pump 115, and an idler gear assembly (or gear assembly) 105 between the hydraulic pump 115 and the dynamoelectric portion 110. The dynamoelectric portion 110 includes a rotor 130 mounted on a shaft 120 that is rotatable about a central axis 125 to allow it to rotate within a stator 135 (shown in part). The rotor 130 includes a plurality of members 140, such as field coils or permanent magnets, circumferentially spaced about the rotor 130 relative to the central axis 125. The general arrangement of dynamoelectric machines is known and may vary from that shown in the illustrated example.

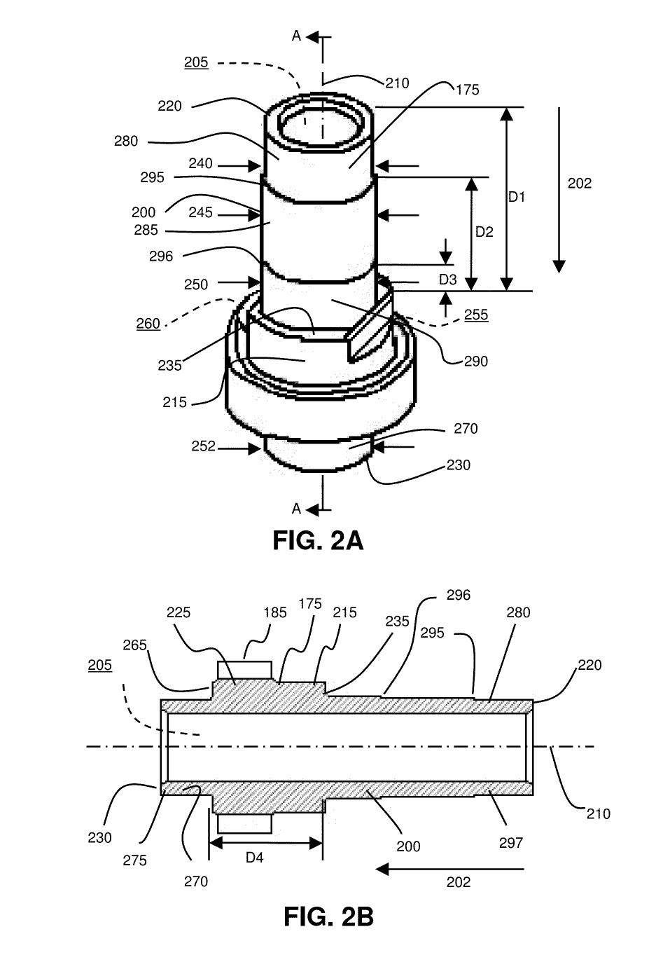

In one embodiment, the gear assembly 105 is configured as a two-piece gear assembly including a first gear 175 (also referred to as a “shaft gear”) coupled to a second gear 180 (also referred to as a “spur gear”). The first gear 175 includes a first set of gear teeth 185 that intermesh with teeth of the pump gear 155 and the second gear 180 includes a second set of gear teeth 190 that intermesh with teeth of the rotor gear 150. The gear teeth 185 and 190 may be involute gear teeth in one embodiment. The first gear 175 and the second gear 180 are coupled together for rotation about a central axis 195. Also, the gear assembly 105 is part of the gear train 145 for driving the hydraulic pump 115 via the dynamoelectric portion 110. In one embodiment, the gear train 145 is a gear reduction train to drive the hydraulic pump 115 at a relatively slower speed than the dynamoelectric portion 110. However, the gear train 145 may be modified in other embodiments. In one embodiment, the gear train 145 includes the rotor gear 150 mounted on the rotor shaft 120, a pump gear 155 mounted on a pump shaft 160 of the hydraulic pump 115, and the idler gear assembly 105 mounted for rotation on journal bearings 165 and 170. In one embodiment, the journal bearings 165 and 170 are constructed from a carbon material impregnated with copper. In an example, the dimensions of the journal bearings 165 and 170 may vary from part to part through normal manufacturing processes, design tolerances, or both such that there is possible position variation of the gear assembly 105 riding in the journal bearings 165 and 170, depending on the particular dimensions of the journal bearings 165 and 170. However, as will be described below in FIGS. 2A-4, the exemplary gear assembly 105 is configured to facilitate reducing any effects from the dimensional variations of the journal bearings 165 and 170.

Referring to FIGS. 2A and 2B, the first gear 175 is generally cylindrical in shape and includes a shaft portion 200 that extends from a first end 220 to a second end 230. The shaft portion 200 includes a bore 205 aligned along shaft axis 210. The bore allows for lubrication oil to flow through the shaft and provide lubrication for the cylindrical portion 280, which receives journal bearing 170 (FIG. 1) on its outer bearing surface 297 (shown in more detail in FIG. 2B). The shaft axis 210 defines the axis of rotation for the first gear 175. Further, the shaft portion 200 is stepped in progressively larger diameters moving in direction 202 from first end 220 to an axial face 235 of a first shoulder 215. As such, the shaft portion 200 increases in outer diameter from end 220 to the axial face 235 of the first shoulder 215 in direction 202.

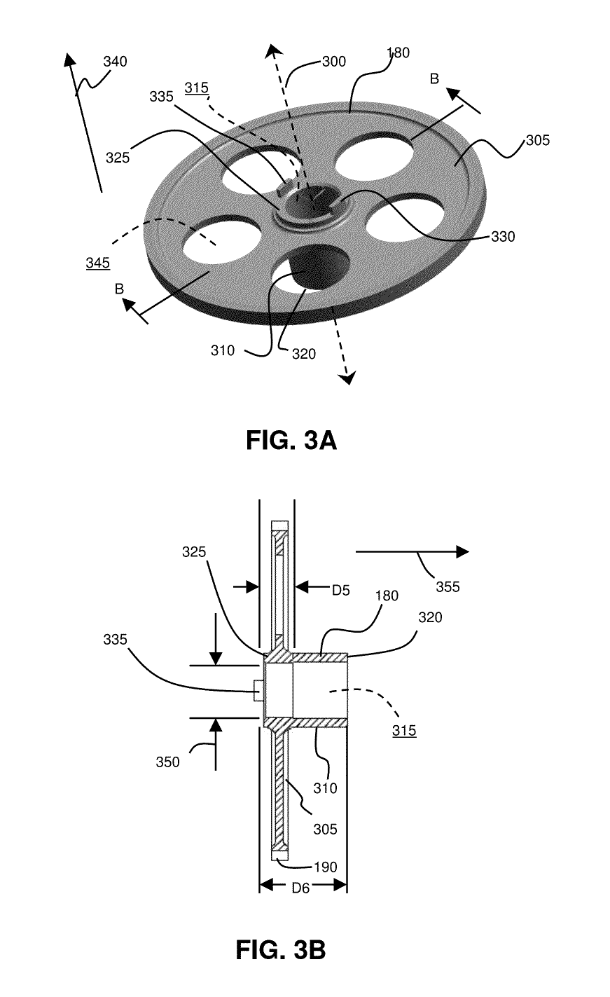

Also shown particularly in FIG. 2A, shaft portion 200 has a first cylindrical portion 280 having an outer diameter 240 for the difference between a first axial distance D1 (i.e., the distance from axial face 235 and end 220) and second axial distance D2 (i.e., the distance from a first machined chamfer 295 and axial face 235), a second cylindrical portion 285 having an outer diameter 245 for the difference between a second axial distance D2 (i.e., the distance from the first machined chamfer 295 and axial face 235) and third axial distance D3 (i.e., the distance from second machined chamfer 296 and axial face 235), a third cylindrical portion 290 having an outer diameter 250 for the difference between third axial distance D3 and axial face 235, and a fourth cylindrical portion 270 having an outer diameter 252 for the distance from axial face 265 (shown in FIG. 2B) and second end 230. In some examples, outer diameter 250 is about 0.6871-0.6875 inches (1.7452 centimeters (cm)-1.7462 cm), outer diameter 245 is about 0.662-0.672 inches (1.682 cm-1.707 cm), and outer diameter 240 is about 0.6455-0.6460 inches (1.639 cm-1.641 cm), D3 is about 0.365-0.375 inches (0.9271 cm-0.9525 cm), D2 is about 0.990-1.000 inches (2.515 cm-2.540 cm), D1 is about 1.395-1.405 inches (3.543 cm-3.569 cm), and outer diameter 252 is about 0.6455-0.6460 inches (1.6396 cm-1.6408 cm). Also, first shoulder 215 includes a plurality of diametrically opposed grooves 255 and 260. In one embodiment, the grooves 255, 260 are formed such that include a plurality of faces that form a right-angle. The grooves 255, 260 are configured to receive complementary drive tangs 330, 335 (FIG. 3A) and reinforce the coupling between first gear 175 and second gear 180 (FIGS. 3A-3B) and prevent the first gear 175 from slipping out of contact with the second gear 180 (i.e. rotating relative to each other) during operation of the gear assembly 105 (FIG. 1) in the gear train 145 (FIG. 1). A sectional view of the first gear 175 taken along the line A-A is described in more detail below in FIG. 2B.

As shown in FIG. 2B, shaft portion 200 includes a second shoulder 225, which has an axial face 265 near the diametrically opposed end 230. The second shoulder 225 includes a first set of gear teeth 185 that are circumferentially located on the outer surface of the shoulder 225. Axial face 265 and surface 275 are bearing surfaces for journal bearing 165 (FIG. 1) while bearing surface 297 is a bearing surface for journal bearing 170 (FIG. 1). For example, the axial face 265 abuts the journal bearing 165 (FIG. 1), which receives fourth cylindrical portion 270 while bearing surface 297 abuts the interior surface of journal bearing 170, which is received on first portion 280. Bearing surface 275 rides inside the journal bearing 165 while bearing surface 297 rides inside the journal bearing 170 to rotatably support the idler gear assembly 105 (FIG. 1) including the first gear 175 and the second gear 180. In an embodiment, full exposure of the gear teeth 185 may be machined to reduce micropitting. In one embodiment, the bearing surfaces 265, 275 (which abuts the interior of journal bearing 165), and 297 (which abuts the interior of journal bearing 170) are machined to have a surface roughness (or surface finish) of 16 micro inches (40.64 micro centimeters). Also, shaft portion 200 has a fourth axial distance D4 (i.e., the distance from axial face 265 and axial face 235) of about 0.762 inches-0.764 inches (1.935 cm-1.941 cm).

FIGS. 3A and 3B illustrate a second gear 180 including a generally circular portion 305 coupled to a shaft portion 310 according to an embodiment of the invention. Particularly, and shown in FIG, 3A, second gear 180 includes a shaft portion 310 having a through aperture or bore 315 from a first end 320 to a second end 325 aligned along shaft axis 300. In an embodiment, the first end 320 is machined to have a surface roughness (or surface finish) of 16 micro inches (40.64 micro centimeters). The shaft axis 300 defines the axis of rotation for the second gear 180. In one embodiment, the shaft axis 300 is aligned with shaft axis 210 (FIG. 2A-2B) of first gear 175, causing axes 210 and 300 to cooperatively define the axis of rotation of gear assembly 105. The circular portion 305 includes a plurality of substantially similar lightening apertures such as, for example, aperture 345 that traverse the circular portion 305 at a radial distance from the axis 300. Also, shaft portion 310 includes a plurality of drive tangs 330 and 335 that emanate from end 325 in direction 340, which is substantially parallel to shaft axis 300. The drive tangs 330, 335 are received in complementary grooves 255, 260 (FIG. 2A). A sectional view of the second gear 180 taken along the line B-B is described in FIG. 3B in more detail.

As shown in FIG. 3B, the shaft portion 310 has an inner diameter 350 for a fifth axial distance D5 that is slightly smaller than the outer diameter 250 of first gear 175 (FIG. 2A and sixth axial distance D6 (i.e., the distance from first end 320 and second end 325). In one example, inner diameter 350 is about 0.6860 inches-0.6864 inches (1.742 cm-1.743 cm), D5 is about 0.365 inches-0.375 inches (0.927-0.952 cm), and D6 is about 1.044 inches-1.046 inches (2.652-2.657 cm). Further, the circular portion 305 includes a second set of gear teeth 190 that are circumferentially located on the perimeter of circular portion 305. In operation, the inner diameter 350 cooperates with the drive tangs 330, 335 (FIG. 3A) to facilitate locking the first gear 175 (FIG. 2A) relative to second gear 180 by receiving first, second and third portions 280, 285, 290 (FIG. 2A) within bore 315 at second end 325. As shaft portion 200 (FIG. 2a) traverses the bore 315 in direction 355, the inner diameter 350 being slightly larger than the outer diameter 250 (FIG. 2A) causes the shaft portion 200 to be in an interference fit or lock with the second gear 180. Additionally, the drive tangs 330, 335 (FIG. 3A) are received in respective grooves 255, 260 (FIG. 2A) and cooperatively prevent the first gear 175 (FIG. 2A) from slipping out of contact with the second gear 180 during operation of the gear assembly 105 (FIG. 1) in the gear train 145 (FIG. 1).

In operation, as shown in FIGS. 2A-2B and 3A-3B, the first gear 175 (FIG. 2A-2B) is coupled to the second gear 180 (FIG. 3A-3B) by inserting portions 280, 285, and 290 (FIG. 2A) into bore 315 (FIG. 3B) at end 325 in direction 355 until the drive tangs 330, 335 (FIG. 3A) abut the grooves 255, 260 (FIG. 2A) and portions 285, 290 (FIG. 2A) are recessed within bore 315 (FIG. 3B), thereby combining the fourth axial distance D4 (FIG. 2B) with the sixth axial distance D6 (FIG. 3B) and causing an interference lock between the shaft portion 200 of first gear 175 (FIG. 2A) and the shaft portion 310 of the second gear 180 (FIG. 3A). In the combination, axial surface 265 (FIG. 2B) axially locates the journal bearing 165 (FIG. 1), while first end 320 of second gear 180 (FIG. 3B) axially locates the journal bearing 170 (FIG. 1), and facilitate reducing any effects from the dimensional variations in the journal bearings 165, 170 (FIG. 1). It is to be appreciated that coupling the first gear 175 (FIG. 2A-2B) to the second gear 180 (FIG. 3A-3B) causes the fourth axial distance D4 (FIG. 2B) to cooperate with sixth axial distance D6 and axially locate the gear teeth 185 (FIG. 2B) and 190 (FIG. 3B) (i.e., control the axial position of the gear teeth 185, 190) between journal bearings 165, 170 (FIG. 1).

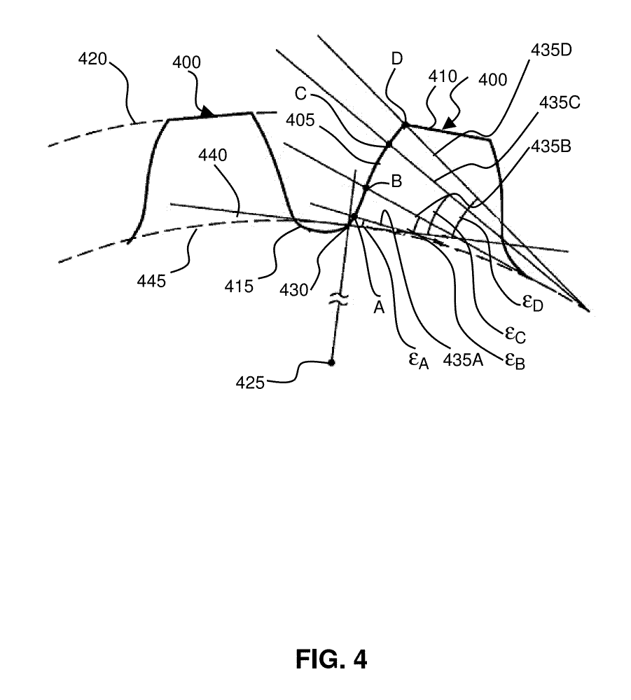

Referring to FIG. 4, each tooth of the first set of teeth 185 (FIG. 1) has a first gear tooth profile and each tooth of the second set of involute teeth 190 (FIG. 1) has a second gear tooth profile that is substantially similar to the first gear tooth profile. Also, the first set of gear teeth 185 (FIG. 2B) and the second set of gear teeth 190 (FIG. 3B) (collectively the teeth 400) are designed with a profile that accommodates the specific loads expected from the high rotational speeds of the gear train 145. For example, the selected tooth profiles facilitate increasing the durability of the gear assembly 105 (FIG. 1). In one embodiment, the teeth 400 are involute teeth that each include at least one involute surface 405 that extends between a tooth tip 410 and a tooth base 415. As an example, the tooth tips 410 may be the surfaces or points of the teeth 400 that form the outermost diameter 420 of the rotor gear 150 (FIG. 1).

Each involute surface 405 may terminate on a radially outer end at the tip 410 and at a radially inner end at a point 425 near the base 415. In one example, the point 430 may represent the point at which the involute surface 405 inflects to form a valley between adjacent teeth 400.

In the profile shown, the involute surface 405 includes at least reference points A-D thereon, with reference point A near the base 415, reference point D near the tip 410, reference point B between reference points A and D, and reference point C being between reference points B and D. In embodiments, reference point A may essentially be at the point 430 of the terminal end of the involute surface 405 and reference point D may essentially be at the radially outer terminal end of the involute surface 405. In some examples, the locations of reference points B and C may be a function of a distance between reference points A and D. In one example, reference point B is located 20% of the distance (from reference point A), and reference point C is located 80% of the distance (from reference point A).

Each of the reference points A-D includes an associated roll angle, ε_{A}-ε_{D}, between a corresponding first line 435A-D and a second line 440 that is tangent at the point 430 to a reference base circle 445 having a center origin at the center axis 425. In one example, the roll angles ε_{A}-ε_{D} are subtended by a portion of the surface 405. The locations of the reference points A-D and the magnitudes of the roll angles ε_{A}-ε_{D} may be determined using a known surface checking machine.

The following examples assume that reference point A is at the point 430 of the terminal end of the involute surface 405, reference point D is at the radially outer terminal end of the involute surface 405, reference point B is located 20% of the distance (from reference point A), and reference point C is located 80% of the distance (from reference point A). In one example, the roll angles ε_{A}-ε_{D} of the first gear 175 are different than the roll angles ε_{A-D} of the second gear 180. That is, the first gear 175 tooth profile is tailored to accommodate the specific loads expected on the first gear 175 and the second gear 180 tooth profile is tailored to accommodate the specific loads expected on the second gear 180, which may be different from the loads on the first gear 175.

In the illustrated example, the gear assembly 105 includes ratios of the roll angles ε_{A}-ε_{D} for the teeth 185 of the first gear 175 to the roll angles ε_{A}-ε_{D} of the teeth 190 of the second gear 180. In one example, a first ratio of the roll angle ε_{A} of the first set of gear teeth 185 to the roll angle ε_{A} of the second set of gear teeth 190 may be 0.08-0.24, a second ratio of the roll angle ε_{B} of the first set of gear teeth 185 to the roll angle ε_{B} of the second set of gear teeth 190 may be 0.4-0.58, a third ratio of the roll angle ε_{C} of the first set of gear teeth 185 to the roll angle ε_{C} of the second set of gear teeth 190 may be 1.09-1.29, and a fourth ratio of the roll angle ε_{D} of the first set of gear teeth 185 to the roll angle ε_{D} of the second set of gear teeth 185 may be 1.26-1.46. In a further example, the first ratio may be 0.12-0.2, the second ratio may be 0.44-0.54, the third ratio may be 1.14-1.24, and the fourth ratio may be 1.31-1.41. In a further example, the first ratio may be 0.16, the second ratio may be 0.49, the third ratio may be 1.19, and the fourth ratio may be 1.36.

The above ratios may be achieved using the following exemplary roll angles ε_{A}-ε_{D}. For example, the roll angle ε_{A} is 1.51 degrees-3.51 degrees, the roll angle ε_{B} is 7.64 degrees-9.64 degrees, the roll angle ε_{C} is 26.03 degrees-28.03 degrees, and the roll angle ε_{D} is 32.16 degrees-34.16 degrees For the first gear 175, which is diametrically smaller than the second gear 180. For the diametrically larger second gear 180, the roll angle ε_{A} is 15.02 degrees-17.02 degrees, the roll angle ε_{B} is 16.7 degrees-18.7 degrees, the roll angle ε_{C} is 21.73 degrees-23.73 degrees, and the roll angle ε_{D} is 23.41 degrees-25.41 degrees.

Utilizing roll angles ε_{A}-ε_{D} within the given ranges for the first gear 175 and the second gear 180 provides a profile of the involute surface 405 that accommodates the expected specific loads on the gear assembly 105 for the expected rotational speeds of the generator 100. Particularly, the radian measures of the given roll angles ε_{A}-ε_{D} are the tangents of the pressure angles at the points on the involute surface 405 and are designed through the given roll angles ε_{A}-ε_{D} to accommodate a particular stress state on the teeth 400.

In a further example, the roll angle ε_{A} is 2.01 degrees-3.01 degrees, the roll angle ε_{B} is 8.14 degrees-9.14 degrees, the roll angle ε_{C} is 26.53 degrees-27.53 degrees, and the roll angle ε_{D} is 32.66 degrees-33.66 degrees for the first gear 175. In a further example, the roll angle ε_{A} is 2.51 degrees, the roll angle ε_{B} is 8.64 degrees, the roll angle ε_{C} is 27.03 degrees, and the roll angle ε_{D} is 33.16 degrees for the first gear 175.

In a further example for the second gear 180, the roll angle ε_{A} is 15.52 degrees-16.52 degrees, the roll angle εB is 17.2 degrees-18.2 degrees, the roll angle ε_{C} is 22.23 degrees-23.23 degrees, and the roll angle ε_{D} is 23.91 degrees-24.91 degrees. In a further example, the roll angle ε_{A} is 16.02 degrees, the roll angle ε_{B} is 17.7 degrees, the roll angle ε_{C} is 22.73 degrees, and the roll angle ε_{D} is 24.41 degrees for the second gear 180. In some examples, the exemplary gear assembly 105 may be used in combination with the rotor gear disclosed in U.S. Patent Application Publication No. 2010/0283343 entitled ROTOR GEAR FOR GENERATOR and the pump gear disclosed in U.S. Patent Application Publication No. 2010/0284835 entitled PUMP GEAR AND PUMP ASSEMBLY FOR A GENERATOR, which are incorporated by reference in their entirety. The gear assembly 105 may also include features of the idler gear disclosed in U.S. Pat. No. 7,926,381 entitled IDLER GEAR AND JOURNAL BEARING ASSEMBLY FOR A GENERATOR, which are incorporated by reference in their entirety.

The gear assembly 105 may be formed with the desired roll angles in a known gear manufacturing process. For instance, the process may include casting, forging, powder metallurgy, and/or machining from a blank. Thus, the process for forming the gear assembly 105 is not limited to any particular type as long as the selected process is capable of establishing the roll angles to be within the given example ranges. The gear assembly 105 may be incorporated into the generator 100 as part of a method of installing the gear train 145. For example, the gear assembly 105 may be a replacement to a prior gear set in the generator 100 that is an original component or a worn component that is to be replaced. In this case, the generator 100 may be at least partially disassembled in a known manner, and the gear assembly 105 may then be inserted into the generator 100 in place of the prior gear assembly.

The technical effects and benefits of embodiments include an idler gear assembly that includes a first gear coupled to a second gear in a gear train of a generator. The first gear includes a first shaft that is provided to receive a complementary bore of the second gear and cause an interference lock between the first gear and the second gear.

The terminology used herein is for the purpose of describing particular embodiments only and is not intended to be limiting of the invention. While the description of the present invention has been presented for purposes of illustration and description, it is not intended to be exhaustive or limited to the invention in the form disclosed. Many modifications, variations, alterations, substitutions, or equivalent arrangement not hereto described will be apparent to those of ordinary skill in the art without departing from the scope and spirit of the invention. Additionally, while various embodiment of the invention have been described, it is to be understood that aspects of the invention may include only some of the described embodiments. Accordingly, the invention is not to be seen as limited by the foregoing description, but is only limited by the scope of the appended claims.

1. An idler gear assembly for a generator, comprising:
a first gear including a first shaft aligned along a first shaft axis from a first end to a diametrically opposed second end, the first shaft comprises a first shoulder having a first axial face and a second shoulder having a second axial face diametrically opposed from the first axial face, diametrically opposed first and second grooves about a circumference of the first shoulder and a first set of teeth circumferentially located about the first shaft axis, the first shaft includes a first axial distance from the first axial face to the second axial face; and
a second gear including a second shaft aligned along a second shaft axis, the second shaft having a diametrically opposed first and second tangs, and a second set of teeth circumferentially located about the second shaft axis, the second shaft includes a second axial distance from a third end to a diametrically opposed fourth end;
wherein the first gear is configured for coupling to the second gear such that the first axial distance and the second axial distance cooperate to locate the first and second gears between diametrically opposed journal bearings;
wherein each of the first shaft axis and the second shaft axis are configured for being aligned along the axis of rotation; and
wherein the first and second groves are configured for coupling to the first and second tangs.

2. The gear assembly of claim 1, wherein the first shoulder is adjacent to the first end of the first shaft and the second shoulder is adjacent to the second end of the first shaft.

3. The gear assembly of claim 1, wherein the first and second tangs are adjacent to the third end.

4. The gear assembly of claim 1, wherein the first shaft is configured for coupling to the second shaft such that the third end is coupled to the first axial face.

5. The gear assembly of claim 2, wherein the first shaft is configured for receiving a first journal bearing between the first axial face and the first end of the first shaft.

6. The gear assembly of claim 4, wherein the first and second shafts cooperate to receive a second journal bearing between the fourth end and the second end of the first shaft.

7. The gear assembly of claim 1, wherein the second gear further comprises a circular portion having opposed top and bottom surfaces, the circular portion aligned along an axis that passes through a geometric center of the top and bottom surfaces, the circular portion being coupled to the second shaft at the geometric center.

8. The idler gear assembly of claim 1, wherein each tooth of both the first set of teeth and the second set of teeth includes a surface that extends between a tooth tip and a tooth base, the surface including at least reference points A-D thereon with reference point A near the base, reference point D near the tip, reference point B between reference points A and D, and reference point C between reference points B and D, the reference points A-D having respective roll angles, ε_{A}-ε_{D}, between a corresponding first line that is perpendicular to the surface at the given reference point A-D and a second line that is tangent at a reference point that lies on a terminal end of the surface at the tooth base to a reference base circle having a center origin at the center axis, for a diametrically smaller one of the first gear and the second gear the roll angle ε_{A} is between 1.51 degrees and 3.51 degrees, the roll angle ε_{B} is between 7.64 degrees and 9.64 degrees, the roll angle εC is between 26.03 degrees and 28.03 degrees, and the roll angle ε_{D} is between 32.16 degrees and 34.16 degrees, and for a diametrically larger one of the first gear and the second gear the roll angle ε_{A} is between 15.02 degrees and 17.02 degrees, the roll angle ε_{B} is between 16.7 degrees and 18.7 degrees, the roll angle ε_{C} is between 21.73 degrees-and 23.73 degrees, and the roll angle ε_{D} is between 23.41 degrees-and 25.41 degrees.

9. The gear assembly of claim 8, wherein the roll angle ε_{A} is between 2.01 degrees and 3.01 degrees, the roll angle ε_{D} is between 8.14 degrees and 9.14 degrees, the roll angle ε_{C} is between 26.53 degrees and 27.53 degrees, and the roll angle ε_{D} is between 32.66 degrees-and 33.66 degrees for the diametrically smaller one of the first gear and the second gear.

10. The gear assembly of claim 8, wherein the roll angle εA is about 2.51 degrees, the roll angle ε_{B} is about 8.64 degrees, the roll angle ε_{C} is about 27.03 degrees, and the roll angle ε_{D} is about 33.16 degrees for the diametrically larger one of the first gear and the second gear.

11. The gear assembly of claim 8, wherein the roll angle ε_{A} is between 15.52 degrees-and 16.52 degrees, the roll angle ε_{B} is between 17.2 degrees and 18.2 degrees, the roll angle ε_{C} is between 22.23 degrees-and 23.23 degrees, and the roll angle ε_{D} is between 23.91 degrees and 24.91 degrees for the diametrically larger one of the first gear and the second gear.

12. The gear assembly of claim 8, wherein a first ratio of the roll angle ε_{A} of the first set of teeth to the roll angle ε_{A} of the second set of teeth is about 0.08-0.24, a second ratio of the roll angle ε_{B} of the first set of teeth to the roll angle ε_{B} of the second set of teeth is about 0.4-0.58, a third ratio of the roll angle ε_{C} of the first set of teeth to the roll angle ε_{C} of the second set of teeth is about 1.09-1.29, and a fourth ratio of the roll angle ε_{D} of the first set of teeth to the roll angle ε_{D} of the second set of teeth is about 1.26-1.46.

13. A shaft gear for a generator, comprising:
a shaft aligned along a shaft axis from a first end to a diametrically opposed second end, the shaft includes a first shoulder having first axial face and a second shoulder having a second axial face diametrically opposed from the first axial face, diametrically opposed first and second grooves about a circumference of the first shoulder and a set of teeth circumferentially located about the shaft axis;
wherein the shaft includes an axial distance from the first axial face to the second axial face;
wherein the shaft includes a first bearing surface defined by the first axial face and the first end of the shaft; and
wherein the shaft is configured for rotation about the shaft axis.

14. The shaft gear of claim 13, wherein the first shoulder is adjacent to the first end and the second shoulder is adjacent to the second end.

15. The shaft gear of claim 13, wherein each tooth of the set of teeth includes a surface that extends between a tooth tip and a tooth base, the surface including at least reference points A-D thereon with reference point A near the base, reference point D near the tip, reference point B between reference points A and D, and reference point C between reference points B and D, the reference points A-D having respective roll angles, ε_{A}-ε_{D}, between a corresponding first line that is perpendicular to the surface at the given reference point A-D and a second line that is tangent at a reference point that lies on a terminal end of the surface at the tooth base to a reference base circle having a center origin at the center axis, and the roll angle ε_{A} is between 1.51 degrees and 3.51 degrees, the roll angle ε_{B} is between 7.64 degrees and 9.64 degrees, the roll angle εC is between 26.03 degrees and 28.03 degrees, and the roll angle ε_{D} is between 32.16 degrees and 34.16 degrees.

16. The shaft gear of claim 15 wherein the roll angle ε_{A} is between 2.01 degrees and 3.01 degrees, the roll angle ε_{B} is between 8.14 degrees and 9.14 degrees, the roll angle ε_{C} is between 26.53 degrees and 27.53 degrees, and the roll angle ε_{D} is between 32.66 degrees and 33.66 degrees.

17. The shaft gear of claim 15, wherein the roll angle ε_{A} is about 2.51 degrees, the roll angle ε_{B} is about 8.64 degrees, the roll angle ε_{C} is about 27.03 degrees, and the roll angle ε_{D} is about 33.16 degrees.

18. A spur gear for a generator, comprising:
a shaft aligned along a shaft axis from a first end to a diametrically opposed second end, the shaft having diametrically opposed first and second tangs at the first end and an axial distance from the first end to the second end;
a circular portion having opposed top and bottom surfaces, the circular portion aligned along an axis that passes through a geometric center of the top and bottom surfaces, the circular portion coupled to the shaft at the geometric center;
wherein the shaft is configured for rotation about the shaft axis; and
wherein the circular portion includes a set of teeth circumferentially located at a perimeter of the circular portion.

19. The spur gear of claim 18, wherein each tooth of the set of teeth includes a surface that extends between a tooth tip and a tooth base, the surface including at least reference points A-D thereon with reference point A near the base, reference point D near the tip, reference point B between reference points A and D, and reference point C between reference points B and D, the reference points A-D having respective roll angles, ε_{A}-ε_{D}, between a corresponding first line that is perpendicular to the surface at the given reference point A-D and a second line that is tangent at a reference point that lies on a terminal end of the surface at the tooth base to a reference base circle having a center origin at the center axis, and the roll angle ε_{A} is between 15.02 degrees and 17.02 degrees, the roll angle ε_{B} is between 16.7 degrees and 18.7 degrees, the roll angle ε_{C} is between 21.73 degrees and 23.73 degrees, and the roll angle ε_{D} is between 23.41 degrees and 25.41 degrees.

20. The spur gear of claim 19, wherein the roll angle ε_{A} is between 15.52 degrees and 16.52 degrees, the roll angle ε_{B} is between 17.2 degrees and 18.2 degrees, the roll angle ε_{C} is between 22.23 degrees and 23.23 degrees, and the roll angle ε_{D} is between 23.91 degrees and 24.91 degrees.

21. The spur gear of claim 19, wherein the roll angle ε_{A} is about 16.02 degrees, the roll angle ε_{D} is about 17.7 degrees, the roll angle ε_{C} is about 22.73 degrees, and the roll angle ε_{D} is about 24.41 degrees for the diametrically larger one of the first gear and the second gear.
